(19) United States
(12) Patent Application Publication
(10) Pub. No.: US 2013/0010671 A1
(43) Pub. Date: Jan. 10, 2013

(54) METHOD AND APPARATUS FOR MANAGING MULTICAST AND BROADCAST SERVICE RESOURCE

(75) Inventors: Eunkyung Kim, Daejeon (KR); Jae Sun Cha, Daejeon (KR); Soojung Jung, Daejeon (KR); Hyun Lee, Daejeon (KR); Chul Sik Yoon, Seoul (KR)

(73) Assignee: ELECTRONICS AND TELECOMMUNICATIONS RESEARCH INSTITUTE, Dejeon (KR)

(21) Appl. No.: 13/635,145

(22) PCT Filed: Mar. 17, 2011
(86) PCT No.: PCT/KR2011/001854

§ 371 Date: Sep. 14, 2012

(30) Foreign Application Priority Data
Mar. 17, 2010 (KR) 10-2010-0023605
Apr. 30, 2010 (KR) 10-2010-0040477
Aug. 6, 2010 (KR) 10-2010-0075860
Mar. 16, 2011 (KR) 10-2011-0023474

(51) Int. Cl. H04W 4/06

(52) U.S. Cl. 370/312

(57) ABSTRACT

When zone allocation information of sub-bands is changed, a terminal receives a new MBS configuration message after a lifetime of an MBS configuration message at a time when the changed zone allocation information is received is expired. The terminal applies the changed zone allocation information at the beginning of the first MSI of the new MBS configuration message.

### TECHNICAL FIELD

The present invention relates to a method and an apparatus for managing a multicast and broadcast service (MBS) resource.

### BACKGROUND ART

The MBS is a point-to-multipoint transmission scheme for concurrent transport of data packets from a source to a plurality of destinations. A broadcast service is a service where data packets are transmitted to all users, and a multicast service is a service where data packets are transmitted to users belonging to a specific group.

For supporting the MBS, a downlink resource i.e., a downlink frame, is divided into a unicast zone and a multicast zone for the MBS.

Sub-bands are divided into sub-band logical resource units (SLRUs) within one subframe, and each MBS zone and the unicast zone are allocated by the SLRUs.

In this case, since the terminal should appropriately receive a corresponding service, it is required that a base station transmits information regarding how the zones are distinguished, information on a time when the zones are distinguished, and information regarding the change of the zones to a terminal.

### DISCLOSURE

### Technical Problem

Aspects of the present invention provide a method and an apparatus for managing an MBS resource for efficiently providing a terminal with information on distinguished zones of a downlink resource when supporting an MBS.

### Technical Solution

According to an aspect of the present invention, a method of managing a MBS resource in a terminal is provided. The method includes receiving a system configuration descriptor (SCD) message including zone allocation information of sub-bands that are divided into a plurality of zones, receiving an MBS configuration message including configuration information for an MBS operation and a lifetime, receiving an SCD message in which the zone allocation information is changed, receiving a new MBS configuration message after the lifetime of the MBS configuration message at a time when the changed SCD message is received expires, and applying the changed zone allocation information at the beginning of the first MBS scheduling interval (MSI) of the new MBS configuration message.

At this time, the plurality of zones may include at least one zone for at least one MBS zone and a zone for a unicast.

The SCD messages may further include a flag representing that the plurality of zones include the zone for the unicast.

The SCD message may further include a count that is incremented when a content of the SCD message is changed.

The method may further include checking a change of the zone allocation information based on the count of the SCD message.

Receiving the new MBS configuration message may include receiving the MBS configuration message at a time that the lifetime indicates.

The zone allocation information includes a bitmap including bits, each having ‘1’ when two adjacent sub-bands correspond to different zones.

The MSI may include a plurality of superframes, and the SCD message may further include information on a length of the MSI.

According to another aspect of the present invention, a method of managing an MBS resource in a base station is provided. The method includes transmitting an SCD message including zone allocation information of sub-bands that are divided into a plurality of zones to a terminal, periodically transmitting an MBS configuration message including configuration information for an MBS operation and a lifetime to a terminal, transmitting another SCD message including changed zone allocation information when the zone allocation information is changed, and applying the changed zone allocation information at the beginning of the first MSI of an MBS configuration message after the lifetime at a time when the zone allocation information is changed expires.

At this time, the plurality of zones may include at least one zone for at least one MBS zone and a zone for a unicast.

The SCD messages may further include a flag representing that the plurality of zones include the zone for the unicast.

The SCD message may further include a count that is incremented when a content of the SCD message is changed.

The zone allocation information may include a bitmap including bits, each setting to ‘1’ when two adjacent sub-bands correspond to different zones.

The MSI may include a plurality of superframes, and the SCD message may further include information on a length of the MSI

According to yet another aspect of the present invention, an apparatus for managing an MBS resource in a terminal is provided. The apparatus includes a receiver and a controller. The receiver periodically receives an SCD message including zone allocation information of sub-bands that are divided into a plurality of zones, and receives an MBS configuration message including configuration information for an MBS operation and a lifetime. When the zone allocation information of the SCD message is changed, the controller applies the changed zone allocation information at the beginning of the first MSI of a next MBS configuration message after the lifetime of an existing MBS configuration message expires.

At this time, the plurality of zones may include at least one zone for at least one MBS zone and a zone for a unicast

The SCD message may further include a count that is incremented when a content of the SCD message is changed, and the controller may check a change of the zone allocation information based on the count of the SCD message.

According to a further aspect of the present invention, an apparatus for managing an MBS resource in a base station is provided. The apparatus includes a transmitter and a controller. The transmitter periodically transmits an SCD message including zone allocation information of sub-bands that are divided into a plurality of zones, and periodically transmits an MBS configuration message including configuration information for an MBS operation and a lifetime. When the zone allocation information is changed, the controller applies the changed zone allocation information at the beginning of the first MSI of a next MBS configuration message after the lifetime of an existing MBS configuration message expires.

At this time, the plurality of zones may include at least one zone for at least one MBS zone and a zone for a unicast.

The SCD message further may include a count that is incremented when a content of the SCD message is changed.

### Advantageous Effects

According to an embodiment of the present invention, a base station and a terminal can apply changed sub-band zone allocation information at an exact time. Further, a terminal that receives data through a unicast can synchronize a changing time of a zone on which the terminal measures a channel with a changing time of a zone that a base station allocates on the unicast.

### DESCRIPTION OF THE DRAWINGS

FIG. 1 is a flowchart showing an MBS supporting method according to an embodiment of the present invention.

FIG. 2 is a drawing showing an SCD message according to an embodiment of the present invention.

FIG. 3 and FIG. 4 are drawings showing one example of zone allocation of a downlink resource, respectively.

FIG. 5 is a drawing showing a change of zone allocation of a downlink resource.

FIG. 6 is a drawing showing a time at which a changed SCD message is applied.

FIG. 7 is a block diagram of an MBS resource managing apparatus of a terminal according to an embodiment of the present invention.

FIG. 8 is a block diagram of an MBS resource managing apparatus of a base station according to an embodiment of the present invention

### MODE FOR INVENTION

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, the term terminal may designate a mobile terminal (MT), a mobile station (MS), a subscriber station (SS), a portable subscriber station (PSS), an access terminal (AT), user equipment (UE), and so on, or may include all or some functions thereof.

Further, the term base station (BS) may designate a node B, an evolved node B (eNodeB), an access point (AP), a radio access station (RAS), a base transceiver station (BTS), an MMR (mobile multihop relay)-BS, and so on, or may include all or some functions thereof.

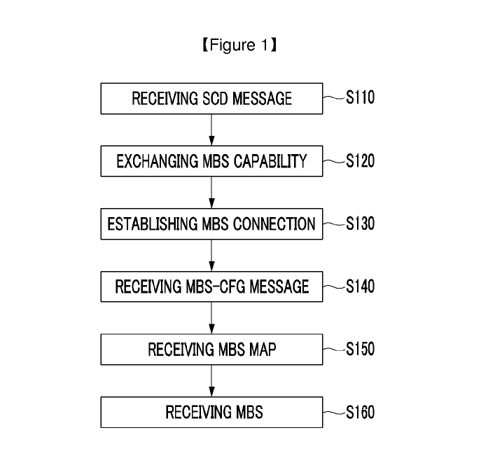

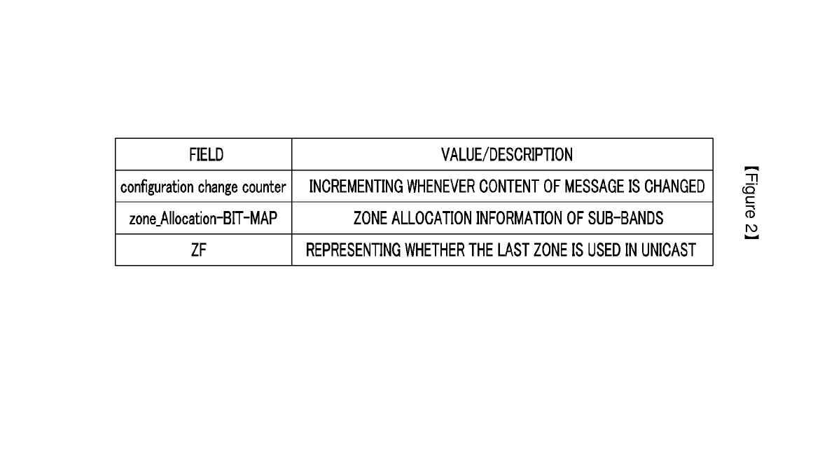

FIG. 1 is a flowchart showing an MBS supporting method according to an embodiment of the present invention, and FIG. 2 is a drawing showing a system configuration descriptor (SCD) message according to an embodiment of the present invention.

Referring to FIG. 1, a base station periodically transmits system configuration information for describing the system configuration to a terminal (S110). The system configuration information may be transmitted through an SCD message.

Referring to FIG. 2, the SCD message includes zone allocation bitmap (Zone_Allocation-Bit-MAP) representing zone allocation information of sub-bands, a zone flag ZF representing whether the last zone is used for a unicast or not, and a configuration change count representing whether a content of the SCD message is changed or not. The configuration change count is incremented whenever the content of the SCD message is changed.

Referring to FIG. 1 again, when the terminal wants to receive the MBS, the terminal transmits information on MBS modes supported by the terminal to a base station, and the base station transmits information on MBS modes that is supported by the base station among the MBS modes supported by the terminal, to the terminal (S120). MBS capability is exchanged between the base station and the terminal through this process. The terminal may transmit MBS mode information through a registration request (REG-REQ) message for requesting registration of network entry or network re-entry. The base station may transmit MBS mode information through a registration response (REG-RSP) message to the REG-REQ message.

Next, the base station transmits a connection establishment request message for establishing MBS connection to the terminal, and the terminal transmits a response message thereto to the base station (S130). A dynamic service addition request (DSA-REQ) message may be used as the connection establishment request message, and a dynamic service addition response (DSA-RSP) message may be used as the response message to the connection establishment request message. Meanwhile, the MBS connection establishment request may be initiated by the terminal. In this case, the terminal may transmit the DSA-REQ message to the base station, and the base station may transmit the DSA-RSP message to the terminal.

The base station periodically transmits an MBS configuration (MBS-CFG) to the terminal, and the terminal receives the MBS-CFG message to acquire MBS configuration information for receiving the MBS (S140). The terminal acquires an MBS MAP based on the MBS configuration information (S150), and receives the MBS from the base station based on information of the MBS MAP (S160).

The MBS-CFG message may be transmitted in a cycle of 32 superframes, and particularly may be transmitted at a superframe satisfying a condition of Equation 1. The MBS-CFG message includes, as the MBS configuration information, an MBS zone identifier (ID), resource information on an MBS MAP applied to the MBS Zone ID, burst size information on the MBS MAP, a neighbor MBS Zone ID, and mapping information of current MBS ID and flow ID (FID) and new MBS ID and FID between a serving MBS zone and a neighbor MBS zone, for each MBS zone. The resource information on the MBS MAP may be a resource index (MBS MAP resource index) representing a location and an allocation size of MBS MAP resources in a sub-band zone allocated to the MBS zone. The burst size information on the MBS MAP may be an offset (MBS MAP I_{SizeOffset}) used to compute a burst size of the MBS MAP. The MBS ID is an identifier that is allocated to the terminal for receiving the MBS. The FID is an identifier allocated to an MBS connection, and is used along with a corresponding MBS ID. The MBS-CFG message further includes a lifetime that represents a duration in which the MBS configuration information does not change. The lifetime indicates when the terminal receives and decodes the MBS-CFG message, and does not count down.

N_{superframe} modulo 32==31 [Equation 1]

The terminal decodes the MBS-CFG message, and acquires information on the MBS MAP applied to the MBS zone to which it belongs to receive the MBS MAP. The terminal does not decode the MBS-CFG message again before a time that the lifetime of the decoded MBS-CFG message indicates, and receives and decodes an MBS-CFG message at the corresponding time. For example, when the lifetime of the MBS-CFG message is ‘m’, the terminal can decode an MBS-CFG message again at a superframe satisfying a condition of Equation 2.

N_{superframe} modulo(32×(m+1))==32×(m+1)−1 [Equation 2]

Here, N_{superframe} is a superframe number.

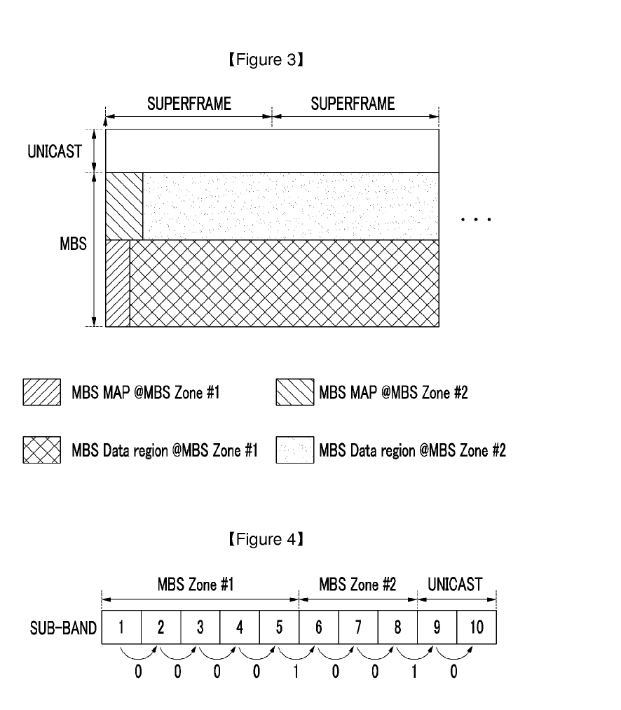

FIG. 3 and FIG. 4 are drawings showing one example of zone allocation of a downlink resource, respectively.

Referring to FIG. 3, sub-bands are divided into zones in a downlink frame, and each sub-band zone is allocated to a corresponding MBS zone (MBS Zone #1 or MBS Zone #2). When unicast resources are required, the zone including the last sub-band is allocated to the unicast.

For example, it is assumed that the sub-bands are divided into 10 sub-bands, the first to fifth sub-bands are allocated to the first MBS zone (MBS Zone #1), the sixth to eighth sub-bands are allocated to the second MBS zone (MBS Zone #2), and the ninth and tenth sub-bands are allocated to the unicast. Then, the zone allocation bitmap (Zone_Allocation-Bit-MAP) may be set to “000010010” as shown in FIG. 4. That is, the total number of bits of the zone allocation bitmap may be set to the difference between the total number of the sub-bands and 1. When the i-th sub-band and the (i+1)-th sub-band belong to different zones, a corresponding bit may be set to ‘1’. When the i-th sub-band and the (i+1)-th sub-band belong to the same zone, a corresponding bit may be set to ‘0’.

As shown in the example of FIG. 3 and FIG. 4, when the unicast is allocated to the zone of the last sub-band, a zone flag (ZF of FIG. 2) of the SDU message may be set to a value representing the allocation of the unicast.

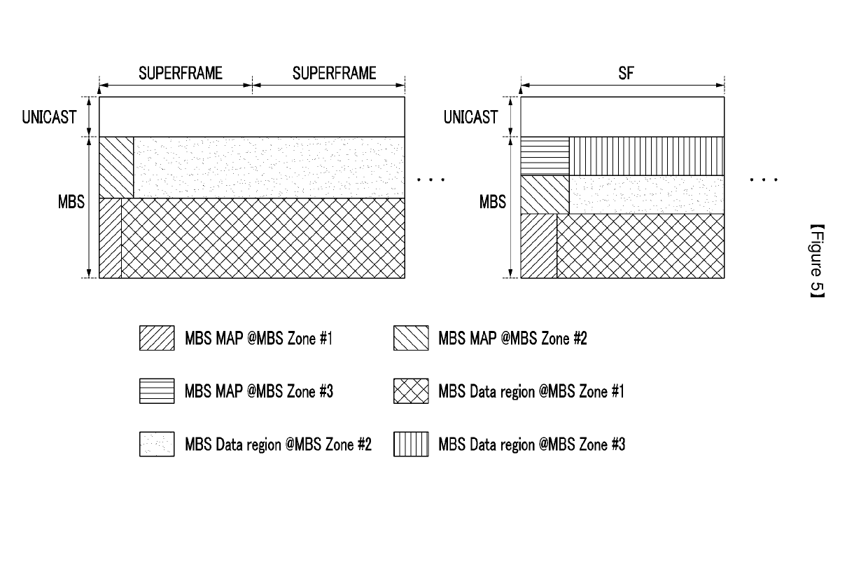

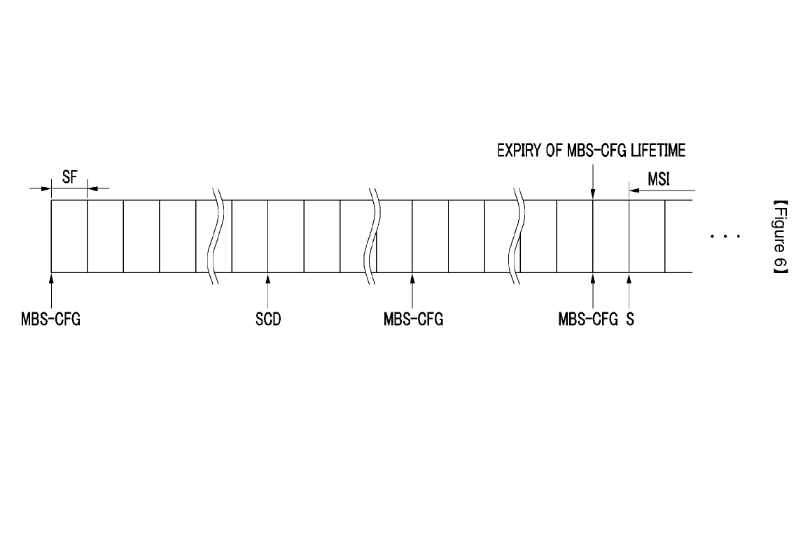

Next, an MBS resource managing method according to an embodiment of the present invention will be described with reference to FIG. 5 and FIG. 6.

FIG. 5 is a drawing showing a change of zone allocation of a downlink resource, and FIG. 6 is a drawing showing a time at which a changed SCD message is applied.

A base station may change zone allocation of sub-bands in a downlink resource. For example, as shown in FIG. 5, a case that the first to third sub-bands are allocated to the first MBS zone (MBS Zone #1), the fourth and fifth sub-bands are allocated to the second MBS zone (MBS Zone #2), the sixth and seventh sub-bands are allocated to the third MBS zone (MBS Zone #3), and the eighth to tenth sub-bands are allocated to the unicast may be changed to a case corresponding to the example of FIG. 3 and FIG. 4.

Then, the base station updates a content of the SCD message, i.e., the zone allocation bitmap, to change sub-band zone allocation information, and transmits the updated SCD message. The base station transmits the SCD message by incrementing a value of a configuration change count by 1, thereby representing the update of the SCD message.

The terminal, which has received unicast data or an MBS based on the existing sub-band zone allocation information, receives the unicast data or the MBS based on the changed sub-band zone allocation information at the beginning of the first MBS Scheduling Interval (MSI), after receiving the changed SCD message.

The MSI is an interval in which traffic is scheduled, and includes successive superframes. An MSI length N_{MS}, representing the number of superframes consisting of the MSI may be transmitted through the SCD message. The MSI may begin at a superframe satisfying a condition of Equation 3.

N_{superframe} modulo N_{MSI}==0 [Equation 3]

Referring to FIG. 5 and FIG. 6, the first MSI to which the sub-band zone allocation information of the changed SCD message is applied means the first MSI within a lifetime of a next MBS-CFG message. That is, if the lifetime of an MBS-CFG message does not expire at a time when the terminal receives the changed SCD message, the terminal receives the MBS from the base station based on information of an MBS MAP that is acquired by the existing MBS-CFG message. If the lifetime of the existing MBS-CFG message expires, the terminal applies the sub-band zone allocation information of the changed SCD message at the beginning of the first MSI within the lifetime of a new MBS-CFG message. The terminal receives the MBS based on the sub-band zone allocation information of the changed SCD message and MBS configuration information of the new MBS-CFG message.

As described above, according to an embodiment of the present invention, although the SCD message is changed, the terminal can receive the MBS based on the existing MBS configuration information if the lifetime of the existing MBS-CFG message does not expire, and can receive the MBS based on the changed SCD message and MBS configuration information of the new MBS-CFG message if the lifetime expires. As a result, the terminal can apply the changed sub-band zone allocation information at an exact time.

Furthermore, a terminal, which receives data through the unicast, can measure channel status on the unicast zone based on the existing sub-band zone allocation information before the changed SCD message is applied, measure the channel status on the unicast zone based on the changed sub-band zone allocation information after the changed SCD message is applied, and feed back measured channel information to the base station. Accordingly, a changing time of the zone on which the terminal measures the channel can be synchronized with a changing time of the zone that the base station allocates on the unicast.

Differently from the embodiment of the present invention, when checking the change of the SCD message through the configuration change count before the lifetime of the existing MBS-CFG message expires, the terminal may receive a next MBS-CFG message without waiting for expiration of the lifetime and apply the sub-band zone allocation information of the new SCD message and the MBS configuration information of the MBS-CFG message. Then, a delay of a time when the changed SCD message is applied can be minimized.

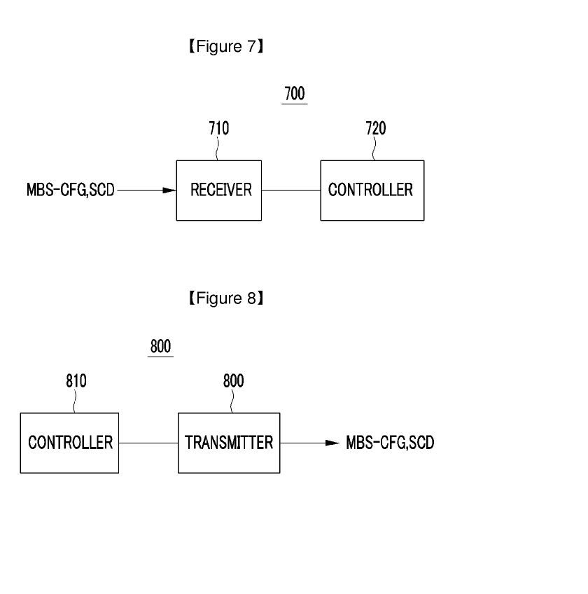

Next, an MBS resource managing apparatus for performing an MBS resource managing method according to an embodiment of the present invention will be described with reference to FIG. 7 and FIG. 8.

FIG. 7 is a block diagram of an MBS resource managing apparatus of a terminal according to an embodiment of the present invention, and FIG. 8 is a block diagram of an MBS resource managing apparatus of a base station according to an embodiment of the present invention.

Referring to FIG. 7, an MBS resource managing apparatus 700 of a terminal includes a receiver 710 and a controller 720.

The receiver 710 receives and decodes an MBS-CFG message and an SCD message transmitted from a base station. The controller 720 controls the receiver 710 to decode the MBS-CFG message that is transmitted at a time that a lifetime of the MBS-CFG message indicates. Further, when checking a change of a content of the SCD message based on a count of the SCD message, the controller 720 applies the changed content of the SCD message at the beginning of the first MSI after the lifetime of the MBS-CFG message expires.

Referring to FIG. 8, an MBS resource managing apparatus 800 of a base station includes a controller 810 and a transmitter 820.

The controller 810 configures an MBS-CFG message and SCD message to be transmitted to a terminal, and increments a system configuration count of the SCD message when sub-band zone allocation information is changed. Further, when a content of the SCD messaged is changed, the controller 810 applies the changed content of the SCD message at the beginning of the first MSI after the lifetime of the MBS-CFG message expires. The transmitter 820 periodically transmits the MBS-CFG message and the SCD message.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

1. A method of managing a multicast and broadcast service (MBS) resource in a terminal, the method comprising:
receiving a system configuration descriptor (SCD) message including zone allocation information of sub-bands that are divided into a plurality of zones;
receiving an MBS configuration message including configuration information for an MBS operation and a lifetime;
receiving an SCD message in which the zone allocation information is changed;
receiving a new MBS configuration message after the lifetime of the MBS configuration message at a time when the changed SCD message is received expires; and
applying the changed zone allocation information at the beginning of the first MBS scheduling interval (MSI) of the new MBS configuration message.

2. The method of claim 1, wherein the plurality of zones include at least one zone for at least one MBS zone and a zone for a unicast.

3. The method of claim 1, wherein the SCD messages further includes a flag representing that the plurality of zones include the zone for the unicast.

4. The method of claim 1, wherein the SCD message further includes a count that is incremented when a content of the SCD message is changed.

5. The method of claim 4, further comprising checking a change of the zone allocation information based on the count of the SCD message.

6. The method of claim 1, wherein receiving the new MBS configuration message includes receiving the MBS configuration message at a time that the lifetime indicates.

7. The method of claim 1, wherein the zone allocation information includes a bitmap including bits, each setting to ‘1’ when two adjacent sub-bands correspond to different zones.

8. The method of claim 1, wherein the MSI includes a plurality of superframes, and
the SCD message further includes information on a length of the MSI.

9. A method of managing a multicast and broadcast service (MBS) resource in a base station, the method comprising:
transmitting a system configuration descriptor (SCD) message to a terminal, the SCD message including zone allocation information of sub-bands that are divided into a plurality of zones;
periodically transmitting an MBS configuration message to a terminal, the MBS configuration message including configuration information for an MBS operation and a lifetime;
transmitting another SCD message when the zone allocation information is changed, the another SCD message including the changed zone allocation information; and
applying the changed zone allocation information at the beginning of the first MBS scheduling interval (MSI) of an MBS configuration message after the lifetime at a time when the zone allocation information is changed expires.

10. The method of claim 9, wherein the plurality of zones include at least one zone for at least one MBS zone and a zone for a unicast.

11. The method of claim 10, wherein the SCD messages further includes a flag representing that the plurality of zones include the zone for the unicast.

12. The method of claim 9, wherein the SCD message further includes a count that is incremented when a content of the SCD message is changed.

13. The method of claim 9, wherein the zone allocation information includes a bitmap including bits, each having ‘1’ when two adjacent sub-bands correspond to different zones.

14. The method of claim 9, wherein the MSI includes a plurality of superframes, and
the SCD message further includes information on a length of the MSI.

15. An apparatus for managing a multicast and broadcast service (MBS) resource in a terminal, the apparatus comprising:
a receiver configured to periodically receive a system configuration descriptor (SCD) message including zone allocation information of sub-bands that are divided into a plurality of zones, and to receive an MBS configuration message including configuration information for an MBS operation and a lifetime; and
a controller configured to, when the zone allocation information of the SCD message is changed, apply the changed zone allocation information at the beginning of the first MBS scheduling interval (MSI) of a next MBS configuration message after the lifetime of an existing MBS configuration message expires.

16. The apparatus of claim 15, wherein the plurality of zones include at least one zone for at least one MBS zone and a zone for a unicast.

17. The apparatus of claim 15, wherein the SCD message further includes a count that is incremented when a content of the SCD message is changed, and
the controller checks a change of the zone allocation information based on the count of the SCD message.

18. An apparatus for managing a multicast and broadcast service (MBS) resource in a base station, the apparatus comprising:
a transmitter configured to periodically transmit a system configuration descriptor (SCD) message including zone allocation information of sub-bands that are divided into a plurality of zones, and to periodically transmit an MBS configuration message including configuration information for an MBS operation and a lifetime; and
a controller configured to, when the zone allocation information is changed, apply the changed zone allocation information at the beginning of the first MBS scheduling interval (MSI) of a next MBS configuration message after the lifetime of an existing MBS configuration message expires.

19. The apparatus of claim 18, wherein the plurality of zones include at least one zone for at least one MBS zone and a zone for a unicast.

20. The apparatus of claim 18, wherein the SCD message further includes a count that is incremented when a content of the SCD message is changed.
